(19) United States
(12) Patent Application Publication
(10) Pub. No.: US 2013/0233875 A1
(43) Pub. Date: Sep. 12, 2013

(54) AUTOMATIC BILL DISCHARGING DEVICE

(71) Applicant: TOSHIBA TEC KABUSHIKI KAISHA, Tokyo (JP)

(72) Inventor: Shinichi Tokunaga, Shizuoka (JP)

(73) Assignee: Toshiba Tec Kabushiki Kaisha, Tokyo (JP)

(21) Appl. No.: 13/784,467

(22) Filed: Mar. 4, 2013

(30) Foreign Application Priority Data
Mar. 6, 2012 (JP) 2012-049591

(51) Int. Cl. G07D 11/00

(52) U.S. Cl. CPC G07D 11/0021
USPC 221/1; 221/208

(57) ABSTRACT

An automatic bill discharging device includes a storing unit which stores a plurality of sheets of bills, a temporary storing unit which includes a bottom plate for supporting a bottom side of the bills in a standing position and temporarily stores the bills therein, a discharging port which is arranged above the temporary storing unit, a conveying mechanism which conveys the bills to the temporary storing unit from the storing unit, and an inclining mechanism which inclines the bills in the temporary storing unit such that a first end of the bills is set higher than a second end of the bills.

### CROSS-REFERENCE TO RELATED APPLICATION

This application is based upon and claims the benefit of priority from Japanese Patent Application No. 2012-049591, filed Mar. 6, 2012, the entire contents of which are incorporated herein by reference.

### FIELD

Embodiments described herein relate generally to an automatic bill discharging device which automatically discharges bills.

### BACKGROUND

Recently, in shops such as supermarkets, a bill discharging device which automatically discharges bills in response to a signal outputted from a Point Of Sales terminal (POS terminal) or an Electronic Cash Register (ECR) has been introduced. This automatic bill discharging device stores bills in a temporary storing chamber in a standing state, and lifts the temporary storing chamber upwardly. The bills are discharged from a discharging port formed on an upper portion of the device.

### DESCRIPTION OF THE DRAWINGS

FIG. 1 is a perspective view of an automatic bill discharging device according to a first embodiment.

FIG. 2 is a block diagram of the automatic bill discharging device according to the first embodiment.

FIG. 3 is a perspective view of a temporary storing chamber and a lifting mechanism of the automatic bill discharging unit according to the first embodiment.

FIG. 4 is a flow chart of a bill discharging operation of the automatic bill discharging device according to a first embodiment.

FIGS. 5A to 5C are views of the lifting mechanism and an inclining mechanism of the first embodiment in different states.

FIGS. 6A to 6C are views of a lifting mechanism according to a second embodiment in different states.

### DETAILED DESCRIPTION

In general, according to one embodiment, an automatic bill discharging device includes: a storing unit configured to store a plurality of sheets of bills; a temporary storing unit having a bottom plate which supports a bottom side of the bills in a standing position and temporarily stores the bills therein; a discharging port arranged above the temporary storing unit; a conveying mechanism configured to convey the bills to the temporary storing unit from the storing unit; and an inclining mechanism configured to incline the bills in the temporary storing unit such that a position of one end of the bills is set higher than a position of the other end of the bills.

According to another embodiment, an automatic bill discharging device includes: a storing unit configured to store a plurality of sheets of bills; a temporary storing unit having a bottom plate which supports a bottom side of the bills in a standing position and temporarily stores the bills therein; a discharging port arranged above the temporary storing unit; a conveying mechanism configured to convey the bills to the temporary storing unit from the storing unit; and an inclining mechanism which inclines the bills such that a position of one end of the bills is set higher than a position of the other end of the bills by pushing one end of the bottom plate upwardly with respect to the other end of the bottom plate.

Hereinafter, further embodiments will be described with reference to the drawings. In the drawings, the same reference numerals used in different drawings denote the same or similar portions.

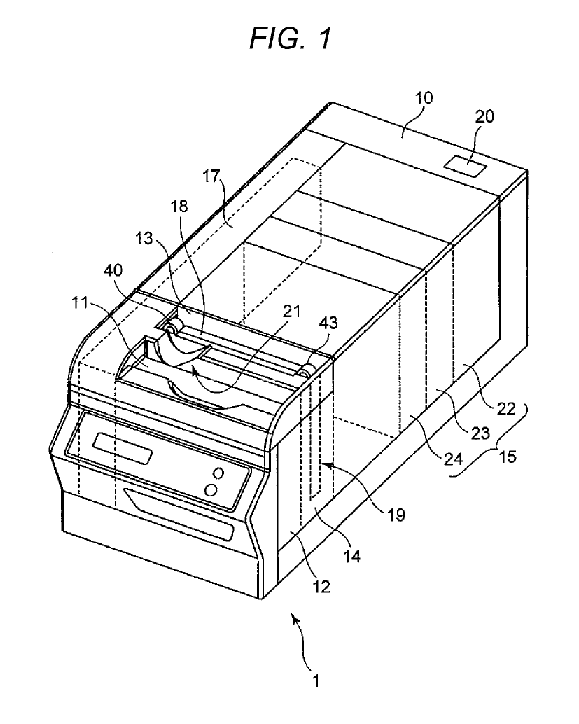

A first embodiment will be described with reference to FIG. 1 to FIG. 5C. FIG. 1 is a perspective view of an automatic bill discharging device. An automatic bill discharging device 1 may be arranged on a register counter of a shop, for example. A housing 10 of the automatic bill discharging device 1 houses a bill receiving unit 12, a bill discharging unit 14, a bill storing unit 15, a conveying mechanism 17, and a controller 20. The bill receiving unit 12 has an upper portion thereof opened thus providing a bill receiving port 11 into which bills are inserted. The bill discharging unit 14 includes a bill discharging port 13, a temporary storing chamber 18 and a lifting mechanism 19. The bill discharging port 13 is arranged in the vicinity of the bill receiving port 11, and has an upper end thereof opened. The temporary storing chamber 18 can be lifted upwardly by the lifting mechanism 19. Bills are discharged from the bill discharging port 13. A bottom portion of the temporary storing chamber 18 is inclined by an inclining mechanism 50.

The bill storing unit 15 includes a first storing unit 22, a second storing unit 23 and a third storing unit 24 for storing bills of different kinds. The conveying mechanism 17 conveys bills from the bill receiving unit 12 to the bill storing unit 15 or from the bill storing unit 15 to the bill discharging unit 14. The controller 20 controls the power supplied to the bill receiving unit 12, the bill discharging unit 14, the bill storing unit 15, the conveying mechanism 17, and the lifting mechanism 19.

The bill receiving port 11 receives bills inserted by an operator. The bill receiving unit 12 separates the bills deposited through the bill receiving port 11 one by one and conveys the bills to a conveying path 16 in a standing state.

The bill discharging port 13 has a rectangular opening. A recessed portion 21 is formed between the bill discharging port 13 and the bill receiving port 11. The recessed portion 21 is positioned on a conveying mechanism 17 side (left side) of the bill discharging port 13. The recessed portion 21 exposes the inside of the temporary storing chamber 18 as viewed from a front side of the device. The operator may easily grasp the bills due to the provision of the recessed portion 21. A space where the bills are stacked is provided below the bill discharging port 13. The bill discharging unit 14, the temporary storing chamber 18 and the lifting mechanism 19 are arranged inside this space. Bills stored in the temporary storing chamber 18 are collectively ejected toward the bill discharging port 13. A width of the bill discharging port 13 in a device width direction is set larger than a long side of the largest bill which can be processed by the device, where the device width direction is defined as the lateral direction while the operator faces a front surface of the housing 10. The bill discharging port 13 may be covered with a shutter.

The bill discharging unit 14 discharges the bills which are conveyed from the conveying mechanism 17 one by one in a standing position to the outside of the device while setting a position of left ends of the bills higher than a position of right ends of the bills.

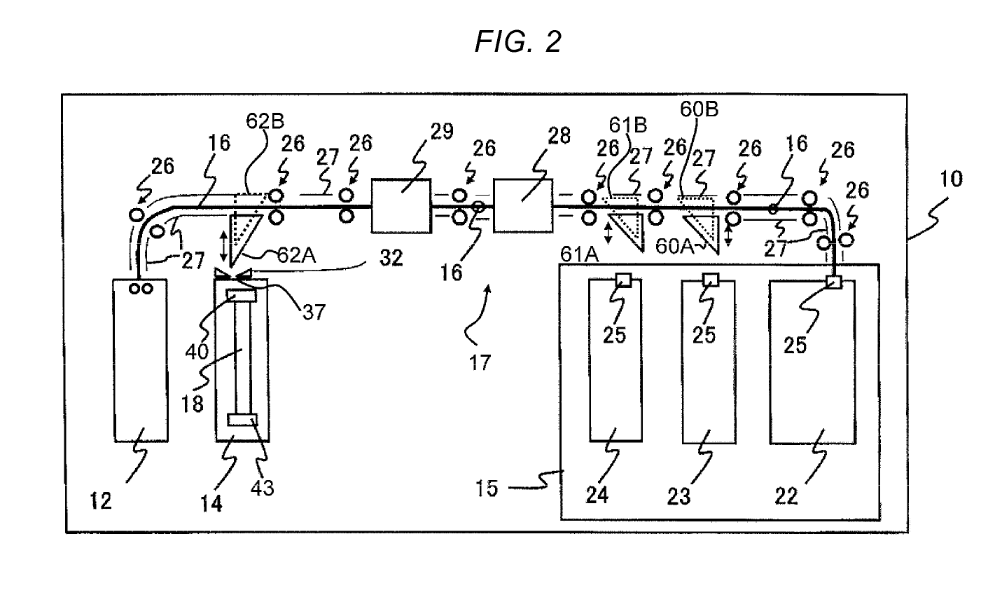

FIG. 2 is a block diagram of the automatic bill discharging device 1. The block diagram is a view of the automatic bill discharging device 1 as viewed from above. The bill storing unit 15 is connected to the bill receiving unit 12 and the bill discharging unit 14 by way of the conveying mechanism 17. The bill storing unit 15 includes a first storing unit 22, a second storing unit 23 and the third storing unit 24. The first storing unit 22 has a rectangular parallelepiped shape. The first storing unit 22 stores bills in a standing state as well as in a state where a long side of the bill is parallel to the device width direction. The first storing unit 22 has a vertically extending narrow slit 25 on one side surface thereof. The slit 25 is formed on the side surface of the first storing unit 22 which faces the conveying mechanism 17.

The first storing unit 22 may include a pair of rollers and an impeller in the vicinity of the slit 25. The rollers provide the function of pulling bills conveyed by the conveying mechanism 17 to the inside of the first storing unit 22. The rollers also provide the function of delivering bills that are inside the first storing unit 22 to the conveying mechanism 17. The first storing unit 22 may include a shutter in the slit 25. The second storing unit 23 and the third storing unit 24 have the same structure as the first storing unit 22. A bill storing capacity of the first storing unit 22 may be larger than bill storing capacities of the second storing unit 23 and the third storing unit 24. The first storing unit 22 may store bills which are used most frequently. The number of storing units may be different depending on the country where the automatic bill discharging device is used.

The conveying mechanism 17 includes a plurality of conveying rollers 26, a plurality of guides 27, identifying sensors 28, 29, and a plurality of gates 30 along the conveying path 16. The conveying path 16 is formed of the plurality of conveying rollers 26 and the plurality of guides 27. The conveying rollers 26 are a pair of rollers. One of the conveying rollers 26 is connected to a motor not shown in the drawing. The rotational direction of the conveying rollers 26 can be changed by changing the driving direction of the motor. The conveying rollers 26 change the conveying direction of bills in response to an instruction from the controller 20.

The identifying sensors 28, 29 perform denomination determination and true or false determination of bills. The identifying sensors 28, 29 maybe of any sensor type, including a light blocking sensor, a reflection-type optical sensor, a transmission-type optical sensor, a magnetic sensor, a material sensor and the like, or any combination of these sensors. The light blocking sensor measures a size of a bill. The reflection-type optical sensor detects a reflection light quantity by irradiating light to a bill. The transmission-type optical sensor detects a transmitting light quantity by irradiating light to a bill. The magnetic sensor detects magnetism generated on a bill. The material sensor measures an electric resistance value of a face of a bill.

A gate 60 is provided between the conveying path 16 and the slit 25 of the second storing unit 23. A gate 61 is provided between the conveying path 16 and the slit 25 of the third storing unit 24. A gate 62 is provided between the conveying path 16 and the bill discharging unit 14. The gates 60, 61, 62 are configured to be movable between a position indicated by a solid line and a position indicated by a dotted line. For example, symbol 60A indicates a standby position of the gate 60. When the gate 60 is moved to a position 60B, a bill is guided to the second storing unit 23 from the conveying path 16 by the gate 60. These gates 60, 61, 62 are controlled by the controller 20.

The bill receiving unit 12 includes discharge rollers for discharging bills one by one to the conveying mechanism 17. The bill discharging unit 14 has a slit 37 which receives bills conveyed by the conveying mechanism 17. A sensor 32 is arranged in the vicinity of the slit 37. The sensor 32 detects passing of a bill which enters the bill discharging unit 14. The light blocking sensor may be used as the sensor 32.

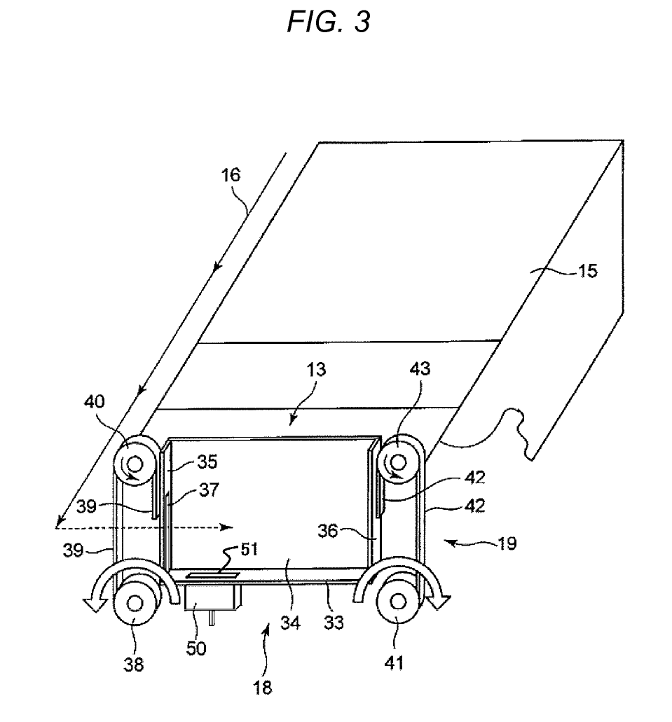

FIG. 3 is a perspective view of the temporary storing chamber 18 and the lifting mechanism 19 of the bill discharging unit 14. The temporary storing chamber 18 is constituted of a bottom plate 33, side walls 35, 36 and a fixed wall 34. The side wall 35 has the slit 37. The slit 37 constitutes an inlet for bills conveyed by the conveying mechanism 17. The temporary storing chamber 18 has a function of sandwiching bills using a drive wall not shown in the drawing and the fixed wall 34. The drive wall is arranged parallel to the fixed wall 34. Each time a bill enters the temporary storing chamber 18 through the slit 37, the drive wall moves in a direction approaching the fixed wall 34, thus pushing the bills to the fixed wall 34. A plurality of impellers and rollers not shown in the drawing are arranged inside the temporary storing chamber 18 so as to pull the bills inside the temporary storing chamber 18.

The inclining mechanism 50 is connected to a lower side of the bottom plate 33. A hole is formed in the bottom plate 33, and a bill lift plate 51 of the inclining mechanism 50 is arranged in the hole. The inclining mechanism 50 includes an actuator inside thereof, which lifts the bill lift plate 51.

The lifting mechanism 19 includes first and second lifting mechanisms. The first lifting mechanism includes a drive roller 38, a belt 39 and a pulley 40. One end of the belt 39 is connected to the side wall 35. The second lifting mechanism includes a drive roller 41, a belt 42 and a pulley 43. One end of the belt 42 is connected to the side wall 36. The drive rollers 38, 41 and the pulley 43 are arranged inside of the automatic bill discharging device 1 to be stationary. By rotating the drive rollers 38, 41 in the directions indicated by arrows, the belts 39, 42 are wound around the drive rollers 38, 41 so that the temporary storing chamber 18 is lifted upwardly.

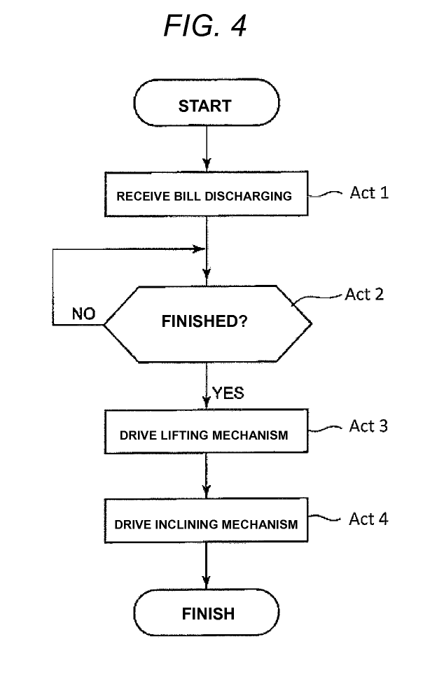

FIG. 4 is a flow chart of a bill discharging operation of the automatic bill discharging device 1. The controller 20 receives a bill discharging instruction from an external host terminal (Act 1). The controller 20 determines the bill type and the number of bills to be discharged in response to the discharging instruction. For example, when the second storing unit 23 discharges three sheets of bills, the controller 20 transmits an instruction to the motor of the conveying mechanism 17 to rotate in the direction that the bills are conveyed to the bill discharging unit 14 from the bill storing unit 15. The gate 60 moves to the position 60B. The gate 62 moves to a position 62B. The rollers inside the second storing unit 23 discharge one sheet of bill through the slit 25. The bill is guided to the conveying mechanism 17 by the gate 60. The bill type is determined by the identifying sensors 28, 29. The controller 20 checks whether or not the conveying bill is genuine or counterfeit.

The gate 62 moves to the position 62B. The bill is guided to the bill discharging unit 14 by the gate 62. The sensor 32 detects passing of the bill. The controller 20 counts the number of sheets of bills in the bill discharging unit 14 based on an output of the sensor 32.

The controller 20 checks whether or not the bills of preset types and of preset number are stored in the bill discharging unit 14 (Act 2). When the bills of right type and of the right number are stacked in the bill discharging unit 14, the controller 20 drives the lifting mechanism 19 so that upper portions of the stacked bills are moved to a position higher than the bill discharging port 13 (Act 3) . When driving of the lifting mechanism 19 is finished, the controller 20 drives the inclining mechanism 50.

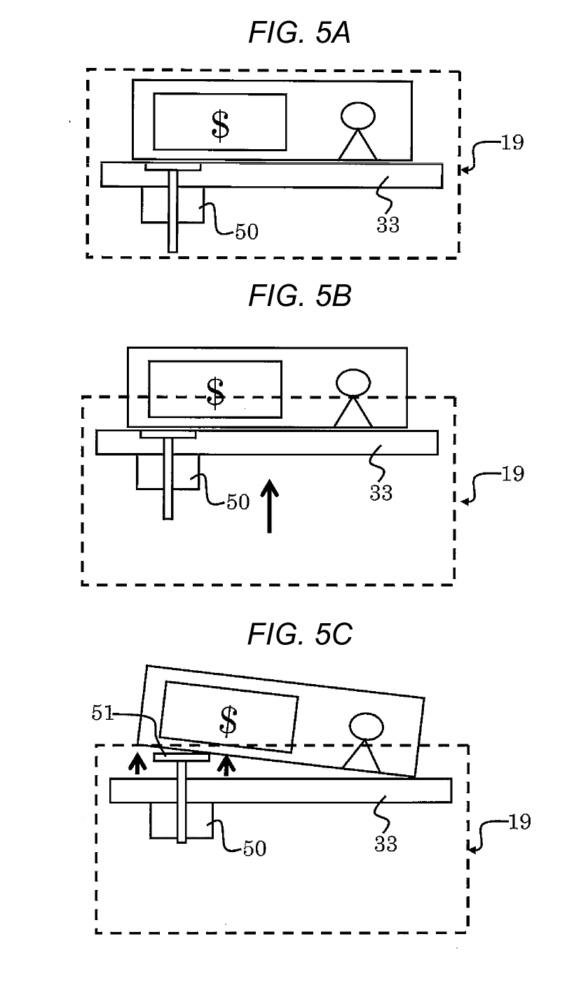

FIG. 5A to FIG. 5C are views of the lifting mechanism 19 and the inclining mechanism 50 in different states. In FIG. 5A, the lifting mechanism 19 is stopped at a position where the lifting mechanism 19 receives bills from the conveying mechanism 17. When an operation of the lifting mechanism 19 is started, as shown in FIG. 5B, the bottom plate 33 of the temporary storing chamber 18 is elevated in the vertical direction. When the operation of the lifting mechanism 19 is stopped, as shown in FIG. 5C, an operation of the inclining mechanism 50 is started so that a left lower side of the bills is lifted by the bill lift plate 51.

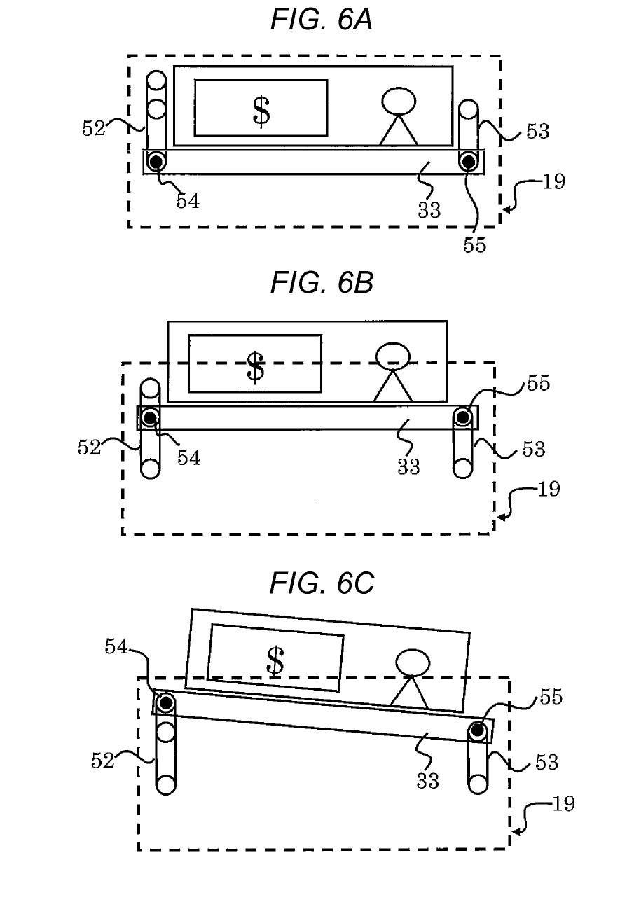

FIG. 6A to FIG. 6C are views of a lifting mechanism 19 according to a second embodiment in different states. The lifting mechanism 19 includes a bottom plate 33, guide rails 52, 53, pivots 54, 55 and a first lifting mechanism and a second lifting mechanism not shown in the drawings. The bottom plate 33 has the pivot 54 on a left end thereof and the pivot 55 on a right end thereof. The guide rails 52, 53 extend in the vertical direction. The guide rail 52 guides the pivot 54 to a position higher than the guide rail 53 in the vertical direction. The pivot 54 is connected to the guide rail 52. The pivot 55 is connected to the guide rail 53.

In FIG. 6A, the lifting mechanism 19 is stopped at a position where the lifting mechanism 19 receives the bills from the conveying mechanism 17. When an operation of the lifting mechanism 19 is started, as shown in FIG. 6B, the bottom plate 33 of a temporary storing chamber 18 is elevated in the vertical direction. The pivot 55 is stopped at an upper end of the guide rail 53. A drive roller 41 of the second lifting mechanism may be stopped at that time. Driving of a drive roller 38 of the first lifting mechanism is continued. The pivot 54 is stopped at an upper end of the guide rail 52 as shown in FIG. 6C. Due to the difference in height between the upper ends of the guide rails 52, 53, a left side of the bottom plate 33 is stopped at a position higher than a position of a right side of the bottom plate 33. Due to the inclining of the bottom plate 33, left ends of the bills are at a position higher than a position of right ends of the bills.

In this embodiment, a left end of a bill discharging port 13 is formed in a recessed shape due to the formation of a recessed portion 21. Further, the lifting mechanism and an inclining mechanism are arranged on a left side in conformity with the recessed portion 21. Accordingly, an operator may easily grasp the left ends of the bills. Further, visibility of discharged bills is enhanced. The recessed portion 21 may be formed on a right end side of the automatic bill discharging device 1.

In the above-mentioned embodiments, various modifications are conceivable with respect to the constitution of the lifting mechanism 19. For example, the lifting mechanism 19 may be a mechanism which pushes the bottom plate 33 by actuators which differ in extension and contraction amount.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic bill discharging device comprising:
a first storing unit configured to store a plurality of sheets of bills;
a second storing unit having a bottom plate which is configured to support a bottom side of the bills in a standing position;
a discharging port arranged above the second storing unit;
a conveying mechanism configured to convey the bills from the first storing unit to the second storing unit; and
an inclining mechanism configured to incline the bills in the second storing unit such that a first end of the bills is set higher than a second end of the bills.

2. The automatic bill discharging device according to claim 1, wherein the inclining mechanism is configured to lift the first end of the bills upwardly.

3. The automatic bill discharging device according to claim 2, wherein the inclining mechanism includes a lift plate configured to lift the first end of the bills and not the second end of the bills.

4. The automatic bill discharging device according to claim 1, wherein the inclining mechanism includes guide rails that are configured to allow the first end of the bills to be lifted higher than the second end of the bills.

5. The automatic bill discharging device according to claim 1, further comprising:
a lifting mechanism configured to move the bottom plate upwardly while the bottom plate is in a horizontal state.

6. The automatic bill discharging device according to claim 1, further comprising:
a cover that covers a front surface of the discharging port, the cover having a recessed portion on a side corresponding to the first end of the bills.

7. The automatic bill discharging device according to claim 1, wherein the second storing unit is configured to support a long edge of the bills on the bottom plate.

8. An automatic bill discharging device comprising:
a first storing unit configured to store a plurality of sheets of bills;
a second storing unit having a bottom plate configured to support a bottom side of the bills in a standing position;
a discharging port arranged above the second storing unit;
a conveying mechanism configured to convey the bills from the first storing unit to the second storing unit; and
an inclining mechanism configured to lift the bottom plate so that a first end of the bills supported by the bottom plate are exposed through the discharging port more than a second end of the bills.

9. The automatic bill discharging device according to claim 8, wherein
the inclining mechanism includes a first guide rail which guides one end of the bottom plate, and a second guide rail which guides the other end of the bottom plate, and
an upper end of the first guide rail is arranged at a higher position than an upper end of the second guide rail.

10. The automatic bill discharging device according to claim 8, further comprising:
a lifting mechanism configured to move the bottom plate upwardly while the bottom plate is in a horizontal state.

11. The automatic bill discharging device according to claim 8, further comprising:
a cover that covers a front surface of the discharging port, the cover having a recessed portion on a side of the first end of the bills.

12. The automatic bill discharging device according to claim 8, wherein the second storing unit is configured to support a long edge of the bills on the bottom plate.

13. The automatic bill discharging device according to claim 8, wherein the inclining mechanism is configured to incline the bottom plate so that the first end of the bills supported by the bottom plate are exposed through the discharging port more than the second end of the bills.

14. The automatic bill discharging device according to claim 13, wherein the inclining mechanism includes a lift plate configured to incline the bottom plate.

15. A method of discharging bills, comprising:
conveying bills from a first storing unit to a second storing unit, the second storing unit having a bottom plate that supports a bottom side of the bills in a standing position; and
inclining the bills in the second storing unit such that a first end of the bills is set higher and exposed more through a discharging port than a second end of the bills.

16. The automatic bill discharging device according to claim 15, wherein the second storing unit is configured to support a long edge of the bills on the bottom plate.

17. The method of claim 16, further comprising:
lifting the bottom plate while maintaining the bottom plate in a horizontal position prior to the inclining.

18. The method of claim 17, wherein the inclining includes:
inclining the bottom plate.

19. The method of claim 18, wherein the bottom plate is inclined by lifting a first end of the support plate and not a second end of the support plate.

20. The method of claim 19, wherein the bottom plate is inclined by guiding a first end of the bottom plate to a first height and a second end of the bottom plate to a second height that is lower than the first height.
